(19) United States
(12) Patent Application Publication
(10) Pub. No.: US 2009/0090396 A1
(43) Pub. Date: Apr. 9, 2009

(54) Method for treating process solution and apparatus for treating substrate

(76) Inventors: Seung-Ho Lee, Daegu (KR); Gui-Su Park, Chungcheongnam-do (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/286,703

(22) Filed: Oct. 1, 2008

(30) Foreign Application Priority Data
Oct. 4, 2007 (KR) 2007-99682

(51) Int. Cl. B08B 3/04; B08B 3/08

(52) U.S. Cl. 134/34; 134/108; 134/57 R; 134/98.1

(57) ABSTRACT

Provided are a method for treating a process solution and an apparatus for treating a substrate using the same. The apparatus includes a treating bath, a circulating line, a bypass line, and a filter. A process solution for a substrate is provided in the treating bath. The circulating line is connected to the treating bath, and the process solution circulates through the circulating line. The bypass line branches from a first position of the circulating line and couples at a second position of the circulating line. The filter is installed in a position of the circulating line between the first position and the second position.

### CROSS-REFERENCE TO RELATED APPLICATION

This U.S. non-provisional patent application claims priority under 35 U.S.C. § 119 of Korean Patent Application No. 10-2007-0099682, filed on Oct. 4, 2007, the entire contents of which are hereby incorporated by reference.

### BACKGROUND OF THE INVENTION

The present invention disclosed herein relates to a method for treating a process solution for performing a process of a semiconductor substrate, and an apparatus for treating a substrate using the same, and more particularly, to a method for treating a process solution with improved process efficiency, and an apparatus for treating a substrate using the same.

A semiconductor memory device or an electronic apparatus such as a flat display device includes a substrate. The substrate can be a silicon wafer or a glass substrate. A plurality of conductive layer patterns is formed on the substrate, and dielectric patterns insulating between different conductive layer patterns are also formed. The conduction layer patterns or the dielectric patterns are formed by a series of processes such as an exposure, a development, and etching.

Some of the series of processes is performed using a treating bath in which a process solution is contained. A plurality of treating baths can be provided depending on an object process. The plurality of treating baths can be treating baths containing the same process solution for performing the same process, or treating tubs containing different process solutions for performing different processes. Also, the treating baths can include a treating bath containing cleaning liquid for cleaning a substrate after the substrate is treated using a process solution.

However, a portion of the process solution is provided to the treating bath before a process for a substrate is performed, and passes through a predetermined preparation operation. For example, a specific process is performed only at high temperature, and the process solution can be heated until it reaches a required temperature. Such a preparation operation delays a process procedure and reduces process efficiency.

### SUMMARY OF THE INVENTION

The present invention provides a method for treating a process solution with improved process efficiency.

The present invention also provides an apparatus for treating a substrate using a process solution.

Embodiments of the present invention provide methods for treating a process solution, the methods including: providing a process solution for a substrate to a treating bath; and circulating the process solution through a circulating line connected to the treating bath. The circulating includes main circulating where the process solution moves along the circulating line, and sub circulating where the process solution moves along the circulating line while passing through a bypass line branching from a first position of the circulating line and then coupling at a second position. The main circulating includes filtering the process solution between the first and second positions.

In other embodiments of the present invention, methods for treating a process solution include providing a process solution for a substrate to a treating bath; and circulating the process solution through a circulating line connected to the treating bath. The circulating includes main circulating where the process solution moves along the circulating line, and sub circulating where the process solution moves along the circulating line while passing through a bypass line branching from a first position of the circulating line and then coupling at a second position. The circulating includes heating the process solution at a position of the circulating line that excludes a portion between the first position and the second position.

In still other embodiments of the present invention, apparatuses for treating a substrate include a treating bath, a circulating line, a bypass line, and a filter. A process solution for a substrate is provided in the treating bath. The circulating line is connected to the treating bath, and the process solution circulates through the circulating line. The bypass line branches from a first position of the circulating line and then couples at a second position of the circulating line. The filter is installed at a position of the circulating line between the first position and the second position.

In even other embodiments of the present invention, apparatuses for treating a substrate include: a treating bath, a circulating line, a bypass line, and a heater. A process solution for a substrate is provided in the treating bath. A circulating line is connected to the treating bath, and the process solution circulates through the circulating line. The bypass line branches from a first position of the circulating line and couples at a second position of the circulating line. The heater is installed at a position of the circulating line that excludes a portion between the first position and the second position.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a perspective view of an apparatus for treating a substrate according to an embodiment of the present invention;

FIG. 2 is a construction view of a sub treating unit illustrated in FIG. 1;

FIG. 3 is a construction view of a circulating part in the sub treating unit of FIG. 2;

FIGS. 4A and 4B are views explaining an operation process of the circulating line of FIG. 3;

FIG. 5 is a construction view of a circulating part of the sub treating unit of FIG. 2 according to another embodiment of the present invention.

FIGS. 6A and 6B are views explaining an operation process of the circulating line of FIG. 5;

FIG. 7 is a flowchart illustrating a method for treating a process solution according to an embodiment of the present invention; and

FIG. 8 is a flowchart illustrating detailed operations of the process solution circulating operation of FIG. 7.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

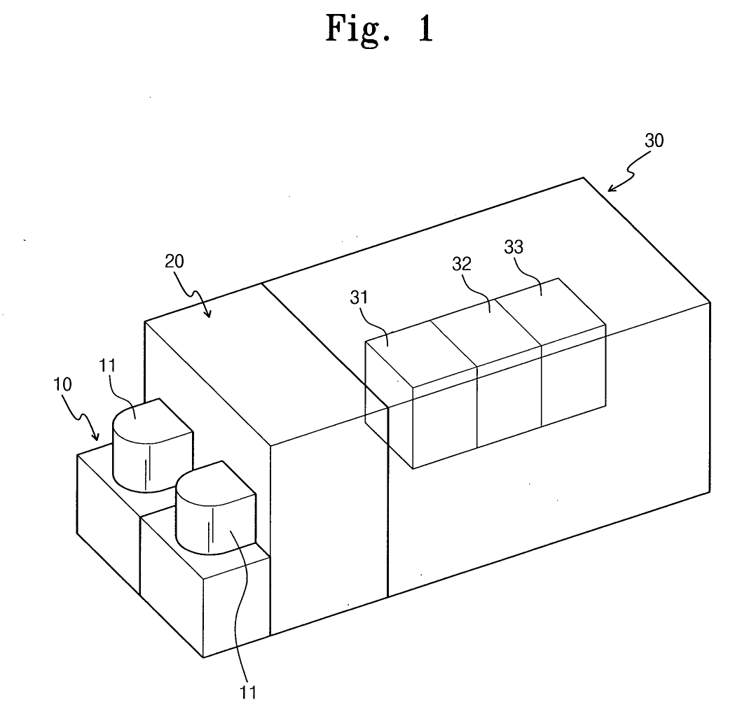

FIG. 1 is a perspective view of an apparatus for treating a substrate according to an embodiment of the present invention.

Referring to FIG. 1, a substrate treating apparatus includes a load port 10, a transfer unit 20, and a treating unit 30. A substrate such as a semiconductor wafer is loaded and unloaded on the load port 10. A plurality of wafers is loaded and unloaded simultaneously at the load port 10 using a cassette 11. The transfer unit 20 receives a wafer from the load port 10 and transfers the wafer to the treating unit 30. A transfer robot (not shown) transferring a wafer is disposed at the lower end of the transfer unit 20.

The treating unit 30 process-treats a wafer transferred from the transfer unit 20. The treating unit 30 includes a plurality of sub treating units. That is, the treating unit 30 includes a first sub treating unit 31, a second sub treating unit 32, and a third sub treating unit 33. The treating unit 30 can further include an additional sub treating unit besides the first through third sub treating units 31, 32, and 33 if necessary. Alternatively, some of the first through third sub treating units 31, 32, and 33 of the treating unit 30 can be omitted.

The first through third sub treating units 31, 32, and 33 can include treating baths, respectively, containing process solutions for performing various processes on a wafer. For example, the process can be etching, cleaning, and drying. During the etching, cleaning, and drying, various solutions of HF, H₂SO₄, deionized water, isopropyl alcohol, etc. can be used for the process solution.

The process solutions contained in the treating baths of the first through third sub treating units 31, 32, and 33 can be the same process solutions for performing the same process. Alternatively, the process solutions contained in the treating baths of the first through third sub treating units 31, 32, and 33 can be process solutions having ingredients different from each other with respect to the same process. Alternatively, the process solutions contained in the treating baths of the first through third sub treating units 31, 32, and 33 can be process solutions different from each other for performing different processes.

The process solution requires a preparation process prior to a process for a substrate. For example, a preparation process providing a process solution to the treating bath to fill the treating bath with the process solution is required. Also, regarding a specific process solution, a process is performed only at high temperature. For this purpose, a preparation process of heating the process solution to high temperature is required. Also, when an ingredient of a process solution changes while a process is performed, the process solution needs to be replaced, and after the replacement, the same preparation process is required. When the preparation process for the process solution is completed, a wafer contained in the cassette 11 is transferred by the transfer robot to the treating unit 30, so that a necessary process is performed. An object wafer is continuously transferred, and a process-completed wafer is transferred to the outside.

As described above, the preparation process for a process solution occupies a considerable portion in the entire wafer process. Therefore, as a time taken during the preparation process increases, a wafer should standby at the load port 10, and so the entire process time is delayed and process efficiency reduces.

In the present embodiment, each of the first through third sub treating units 31, 32, and 33 can minimize a preparation time of the process solution to prevent a process delay. Hereinafter, a structure of preventing the process delay is described through one of the first through third sub treating units 31, 32, and 33. However, the structure below is not necessarily applied to all of the plurality of sub treating units. That is, an excessive time may not be taken during the preparation process for a process solution at some of the plurality of sub treating units, and the structure below may not be applied to such a sub treating unit.

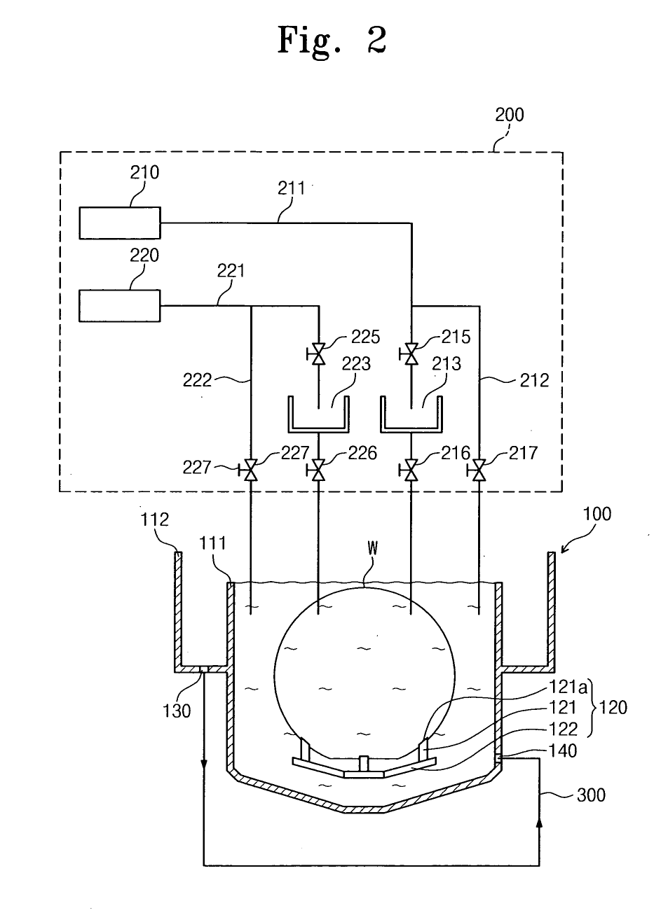

FIG. 2 is a construction view of a sub treating unit illustrated in FIG. 1.

Referring to FIG. 2, the sub treating unit includes a treating bath 100, a supply part 200, and a circulating part 300. A process for a semiconductor substrate such as a wafer W is performed in the treating bath 100. The supply part 200 provides a process solution to the treating bath 100. The circulating part 300 circulates a process solution provided to the treating bath 100.

Specifically, the treating bath 100 includes an inner bath 111 and an outer bath 112. The inner bath 111 has an open upper portion to receive a process solution from above. A discharge hole (not shown) for discharging a process solution is formed in the bottom of the inner bath 111. The outer bath 112 surrounds the outer side of the inner bath 111 and accommodates the process solution flooding from the inner bath 111.

A guide 120 is installed inside the inner bath 111 and supports a wafer W during the process. The guide 120 includes a plurality of support rods 121 arranged in parallel to each other, and a coupling plate 122 connecting these support rods 121. Slots 121a for receiving the partial edge of the wafer W are formed in each support rod along the lengthwise direction of each support rod. About 25 through 50 slots 121a are formed, so that the guide 120 can simultaneously support about 25 through 50 wafers.

An outlet 130 is formed in the outer bath 112, and an inlet 140 is formed in the inner bath 111. The outlet 130 and the inlet 140 are connected with the circulating part 300. The circulating part 300 circulates a process solution from the outlet 130 to provide the process solution to the treating bath 100 through the inlet 140. The detailed structure of the circulating part 300 is described later.

The supply part 200 provides two different process solutions. Hereinafter, the two process solutions are called a first process solution and a second process solution. To provide the first process solution, the supply part 200 includes a first container 210 in which a first process solution is stored, and a first supply line 211 through which the first process solution moves. A first auxiliary supply line 212 branches from a predetermined position of the first supply line 211. The first auxiliary supply line 212 is connected to the treating bath 100. One side of the first supply line 211 is connected to the first container 210, and the other side is connected to the treating bath 100. Also, an auxiliary container 213 is provided to the first supply line 211. Valves 215 and 216 are installed at the front and back of the first auxiliary container 213 on the first supply line 211. Also, a valve 217 is installed on the first auxiliary supply line 212. Each of the valves 215, 216, and 217 controls flow of the first process solution at its installation position.

Like the first process solution, the supply part 200 includes a second container 220, a second supply line 221, a second auxiliary supply line 222, a second auxiliary container 223, and a plurality of valves 225, 226, and 227 in order to supply the second process solution.

The first supply line 211 provides the first process solution to the treating bath 100. The first auxiliary container 213 controls an amount of the first process solution supplied to the treating bath 100. The first auxiliary supply line 212 complements the supplying of the first process solution. Likewise, the second supply line 221 provides the second process solution to the treating bath 100. The second auxiliary container 223 controls an amount of the second process solution supplied to the treating bath 100. The second auxiliary supply line 222 complements the supplying of the second process solution.

If the process at the treating bath 100 is a cleaning process for cleaning a wafer W, the process solution can be a compound of H₂SO₄ and H₂O₂. In this case, the first process solution is H₂SO₄, and the second process solution is H₂O₂. H₂SO₄ and H₂O₂ are stored in the separate first and second containers 210 and 220, respectively, and supplied separately, and then mixed in the treating bath 100.

Meanwhile, an SC-1 type wet cleaning can be applied to clean a wafer W. In this case, the process solution includes H₂O₂, NH₄OH, and pure water. In the case where the process solution includes a solution of three different ingredients, separate container, supply line, auxiliary supply line, auxiliary container, and a plurality of valves are added to the supply part 200. In the case where the process solution is a compound of four or more solutions, a separate container, etc. is added depending on the kind of the process solution. Meanwhile, only one kind of process solution is used alone as the process solution, the second container 220, the second supply line 221, the second auxiliary supply line 222, the second auxiliary container 223, and the plurality of valves 225, 226, and 227 can be omitted from the supply part 200.

In the embodiment shown in FIG. 2, a batch type structure allowing a plurality of wafers W to be immersed in the process solution and treating the wafers at a time has been described. Unlike this, the present invention can be also applied to a single wafer processing structure providing a process solution to a rotating wafer and performing a process.

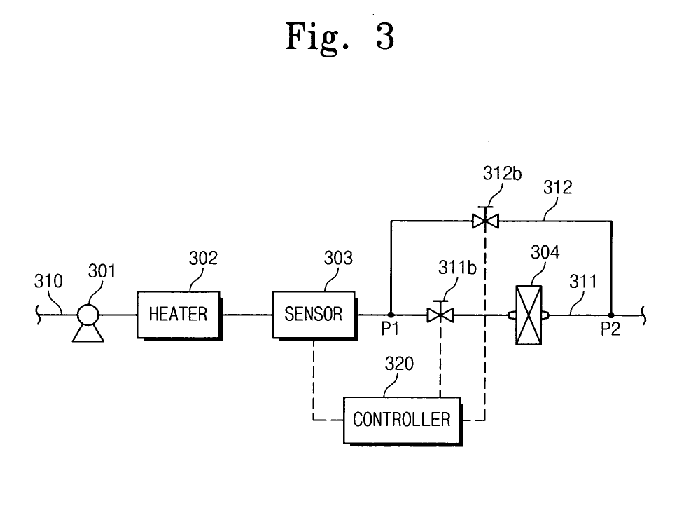

FIG. 3 is a construction view of a circulating part in the sub treating unit of FIG. 2.

Referring to FIG. 3, the circulating part 300 includes a pump 301, a heater 302, a sensor 303, a filter 304, a circulating line 310, and a controller 320. The circulating line 310 includes a bypass line branching between a first position P1 and a second position P2. For convenience in description, a portion of the circulating line 310 between the first and second positions P1 and P2 is called a first line 311, and the bypass line is called a second line 312. A first valve 311b is installed on the first line 311, and a second valve 312b is installed on the second line 312.

The pump 301, the heater 302, the sensor 303, and the filter 304 are installed on the circulating line 310. The pump 301, the heater 302, and the sensor 303 are installed on positions of the circulating line 310 that excludes the first line 311 located between the first and second positions P1 and P2. As long as the pump 301, the heater 302, and the sensor 303 are installed on the positions of the circulating line 310 that exclude the first line 311, they can be installed in a different order or on different positions shown in FIG. 3.

The controller 320 is connected with the sensor 303, the first valve 311b, and the second valve 312b. The controller 320 controls flow of a process solution while controlling open/close of the first and second valves 311b and 312b using information received from the sensor 303. However, in controlling the flow of the process solution, the flow of the process solution can be controlled using a manual operation even when the controller 320 is present as is known in the following description of the operation process.

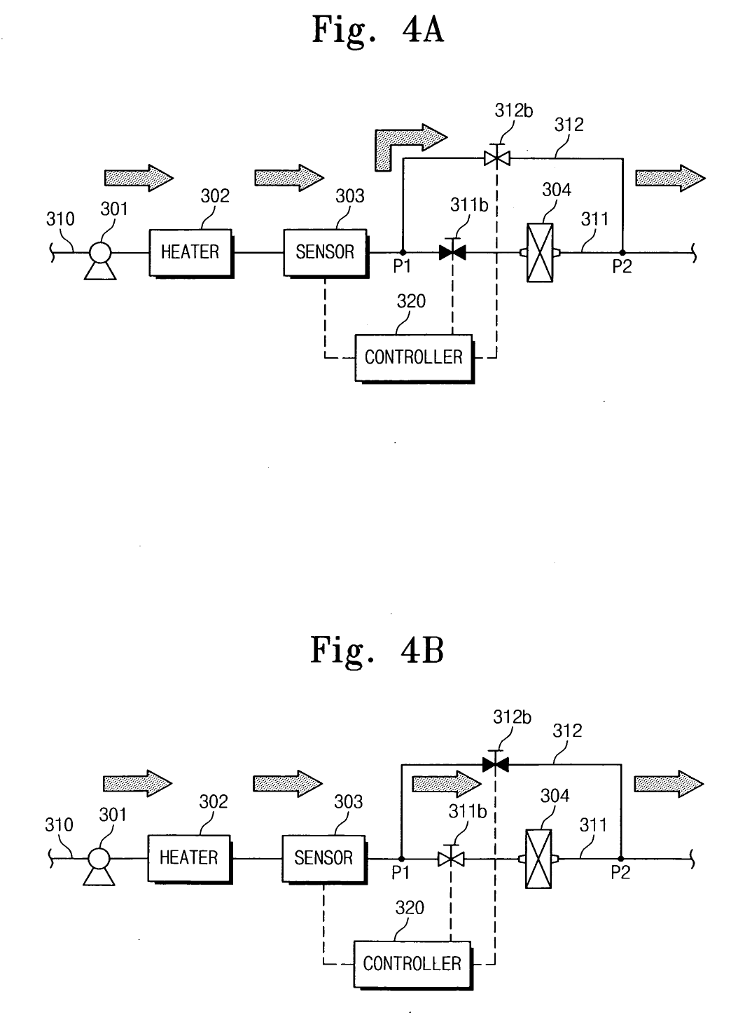

FIGS. 4A and 4B are views explaining an operation process of the circulating line of FIG. 3.

Referring to FIG. 4A, a process solution provided to the treating bath 100 obtains power from the operation of the pump 301 to move along the circulating line 310. The process solution passes through the heater 302 by way of the pump 301, and is heated at the heater 302 to a predetermined temperature. The temperature of the process solution heated at the heater 302 is sensed by the sensor 303. The controller 320 controls the process solution to move to the first line 311 or the second line 312 depending on the sensed temperature.

Specifically, when the temperature of the process solution is smaller than a predetermined set value, the controller 320 closes the first valve 311b and opens the second valve 312b to induce the process solution to flow to the second line 312. The process solution passes through the second line 312 and returns to the treating bath 100 along the circulating line 310. The above circulating process is repeated several times, and the temperature of the process solution is raised through the repeated process.

Referring to FIG. 4B, the temperature of the process solution reaches a set value through the repeated circulation. When it is sensed by the sensor 303 that the temperature of the process solution becomes the set value or more, the controller 320 opens the first valve 311b and closes the second valve 312b to induce the process solution to flow to the first line 311. The process solution passes through the filter 304 on the first line 311. Impurities of the process solution are filtered by the filter 304 and the impurity-filtered process solution returns to the treating bath 100 along the circulating line 310. The above circulating process is repeated several times until the temperature of the process solution is raised to reach an object value. After the temperature of the process solution reaches the object value, a wafer W is provided and a relevant process is performed at the treating bath 100.

When the process solution is controlled to flow to the first line 311 or the second line 312 depending on a temperature range, the following advantages can be obtained. As described above, various solutions can be used as the process solution depending on the kind of the process. The advantages of the present embodiment are described using an example where the process solution is a compound of H₂SO₄ and H₂O₂.

H₂SO₄ has high viscosity, so that it does not easily flow at low temperature. That is, when moving along the circulating line 310, H₂SO₄ receives high pressure from the pump 301 at low temperature. Particularly, it is difficult for H₂SO₄ to pass through the filter 304 of the first line 311 due to the high viscosity of H₂SO₄ at low temperature. Consequently, it takes much time for H₂SO₄ to pass through the filter 304, and thus the entire process time may be considerably delayed.

According to the present embodiment, H₂SO₄ flows to the second line 312 at low temperature so that it may not pass through the filter 304, and thus a time taken for circulation reduces. Also, when the temperature of H₂SO₄ reaches a set value and so the viscosity of H₂SO₄ becomes low, the movement path is changed and H₂SO₄ passes through the first line 311, so that impurities of H₂SO₄ can be removed through the filter 304.

The set value and the object value change depending on an object process and the kind of the process solution used for the object process. In case of H₂SO₄, the set value is about 50° C. to about 60° C., and the object valve is about 120° C. to about 150° C. That is, the viscosity of H₂SO₄ reduces at the set value and H₂SO₄ readily moves along the circulating line 310, and when the temperature of H₂SO₄ reaches the object value, a process for a wafer W is performed.

Hereinafter, another embodiment forming a bypass path is described.

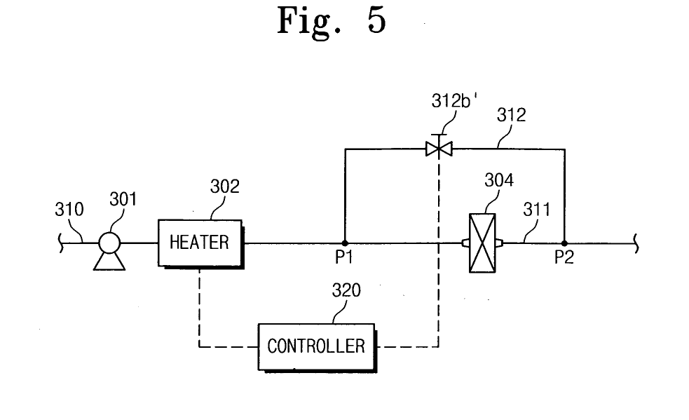

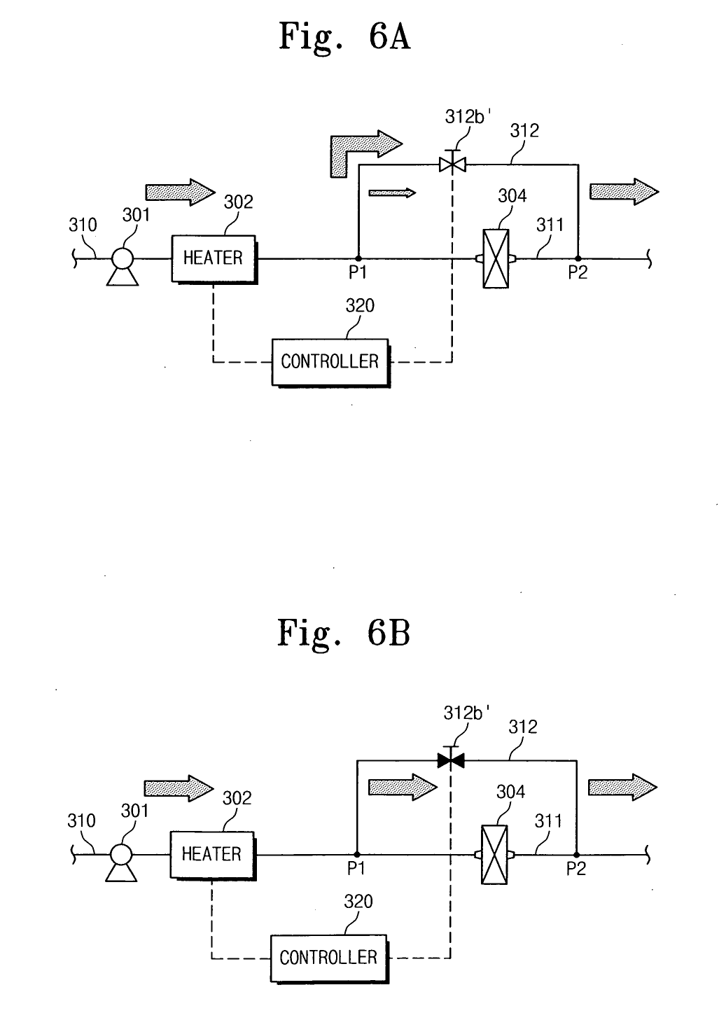

FIG. 5 is a construction view of a circulating part of the sub treating unit of FIG. 2 according to another embodiment of the present invention, and FIGS. 6A and 6B are views explaining an operation process of the circulating line of FIG. 5. In the description of the another embodiment, same reference numerals are used for the same elements as those of the previous embodiment, and detailed descriptions thereof are omitted.

Referring to FIG. 5, the circulating part 300 includes a pump 301, a heater 302, a filter 304, a circulating line 310, and a controller 320. The circulating line 310 is divided into a first line 311 and a second line 312 between the a first position P1 and a second position P2. The second line 312 is a bypass line branching between the first and second positions P1 and P2. The heater 302 includes a temperature sensing sensor therein, and a separate sensor is not installed on the circulating line 310. No separate valve is installed on the first line 311 and a valve 312b′ is installed on only the second line 312. The controller 320 is connected to the heater 302 and the valve 312b′, and controls open/close of the valve 312b′.

Referring to FIG. 6A, the process solution obtains power from the pump 301 to move along the circulating line 310. The process solution passes through the heater 302 by way of the pump 301. The process solution is heated by the heater 302, and the temperature of the process solution is sensed by the temperature sensing sensor included in the heater 302. When the temperature of the process solution is smaller than a set value, the controller 320 opens the valve 312b′.

As the valve 312b′ is opened, the process solution flows through the first and the second lines 311 and 312, simultaneously. However, since the temperature of the process solution is low, the process solution flowing through the first line 311 cannot readily pass through the filter 304 but accumulates. On the other hand, the process solution flowing through the second line 312 readily moves. Therefore, most of the process solution flows through the second line 312, while only a portion of the process solution flows through the first line 311. As described above, while the second line 312 is opened so that the process solution readily circulates, the process solution is heated fast to a set value.

Referring to FIG. 6B, when the temperature of the process solution reaches the set value through the above repeated circulation, the valve 312b′ is closed to block the second line 312. In the first line, the process solution is filtered while it passes through the filter 304, and when the temperature of the process solution reaches an object value through the repeated circulation, the circulation is ended and a wafer W is provided, so that a relevant process is performed at a treating bath 100.

According to the present embodiment, a delay of the process procedure is prevented, and valve installation at the first line 311 can be omitted, which is economical.

Hereinafter, a method for treating a process solution that is applied to the above apparatus is described. Since the following embodiment relates to a method using the above apparatus, the same reference numerals as those used for the apparatus are used. However, in performing the method for treating the process solution, the above apparatus is not necessarily used.

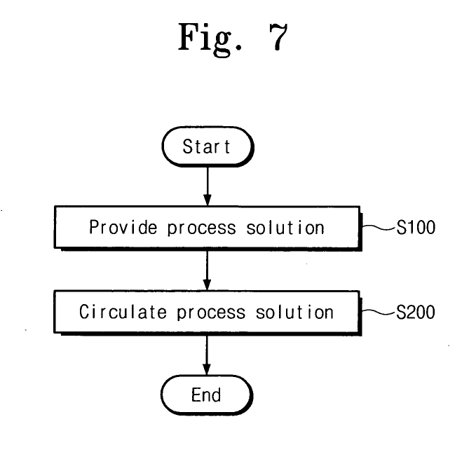

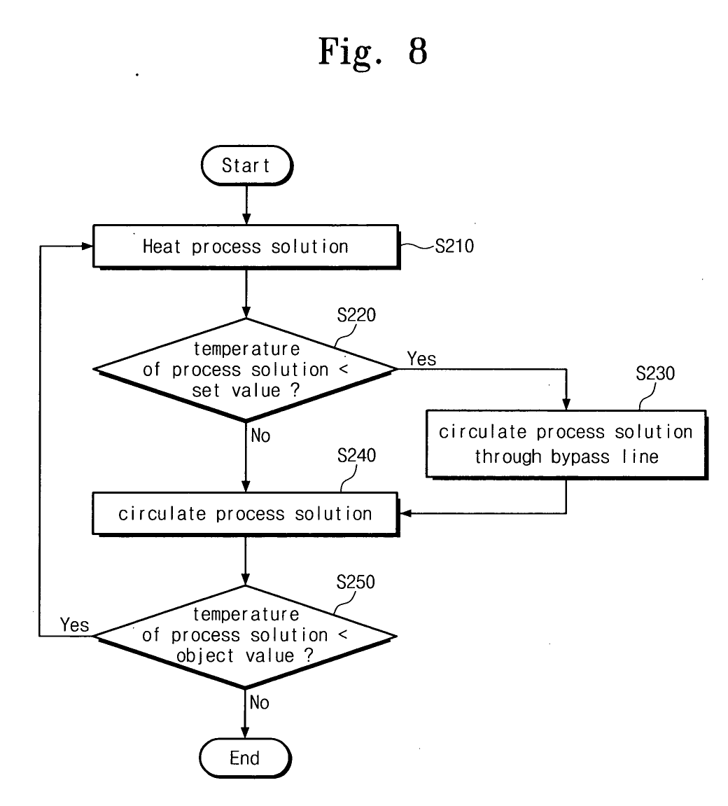

FIG. 7 is a flowchart illustrating a method for treating a process solution according to an embodiment of the present invention, and FIG. 8 is a flowchart illustrating detailed operations of the process solution circulating operation of FIG. 7.

Referring to FIG. 7, the method for treating the process solution includes providing a process solution (S100), and circulating the process solution (S200). The providing of the process solution (S100) includes supplying the process solution from the supply part 200 to the treating bath 100. The circulating of the process solution (S200) includes heating the process solution provided from the treating bath 100 to an object value while circulating the process solution through the circulation part 300.

Referring to FIG. 8, the circulating of the process solution (S200) includes a plurality of processes. In operation S210 of heating the process solution, the heater 302 installed on the circulating line 300 heats the process solution. After heating, the temperature of the process solution is compared with a set value (S220). When the temperature of the process solution is lower than the set value as a result of the comparison, the process solution is controlled to pass through the bypass line (S230) and circulate through the circulating line 310 (S240). On the other hand, when the temperature of the process solution is higher than the set value, the process solution is controlled to circulate through the circulating line 310 without passing through the bypass line.

The temperature of the process solution is compared with the object value every circulation (S250). When the temperature of the process solution is lower than the object value as a result of the comparison, the circulation process is repeated. On the other hand, when the temperature of the process solution is higher than the object value as a result of the comparison, the circulation of the process solution is completed and a process for a wafer W is performed.

While the process for the wafer W is performed, the component of the process solution can change due to chemical reaction between the wafer W and the process solution. Therefore, even while the process is performed, the process solution can be circulated so that its component can be maintained.

The above embodiment has described an example where the process solution is controlled not to pass through the filter 304 by controlling the process solution to flow through the bypass line until the temperature of the process solution reaches the set value. However, the above embodiment is not limited to the above case but can be variously applied. For example, the set value or the object value can correspond to another condition such as concentration, not temperature. The filter 304 can correspond to a predetermined different element. When an excessive time is taken for the process solution to pass through a predetermined element until the process solution reaches a predetermined set value, a bypass line can be installed before and after the element. The process solution is controlled to bypass the element using the bypass line until the process solution satisfies the set value, so that process delay by the element is prevented. After that, when the process solution satisfies the set value, a path using the bypass line is blocked, and the process solution is controlled to pass through the element.

As described above, according to the embodiments, the process procedure is prevented from being delayed in preparing the process solution, so that process efficiency improves. However, the embodiments are exemplarily described, and it will be understood by those of ordinary skill in the art that various changes in form and details may be made therein without departing from the spirit and scope of the present invention as defined by the following claims.

What is claimed is:

1. A method for treating a process solution, the method comprising:
providing a process solution for a substrate to a treating bath; and
circulating the process solution through a circulating line connected to the treating bath,
the circulating the process solution comprising:
main circulating where the process solution moves along the circulating line; and
sub circulating where the process solution moves along the circulating line while passing through a bypass line branching from a first position of the circulating line and then coupling at a second position,
wherein the main circulating comprising filtering the process solution between the first and second positions.

2. The method of claim 1, wherein the circulating comprises heating the process solution at a position of the circulating line that excludes a potion between the first position and the second position.

3. The method of claim 2, wherein the sub circulating is performed when temperature of the process solution is smaller than a set value.

4. The method of claim 3, wherein the main circulating is performed when the temperature of the process solution is greater than the set value.

5. The method of claim 3, wherein the set value is about 50° C. to about 60° C.

6. The method of claim 3, wherein the main circulating is performed until the temperature of the process solution becomes about 120° C. to about 150° C.

7. The method of claim 1, wherein the process solution comprises H₂SO₄.

8. A method for treating a process solution, the method comprising:
providing a process solution for a substrate to a treating bath; and
circulating the process solution through a circulating line connected to the treating bath,
the circulating the process solution comprising:
main circulating where the process solution moves along the circulating line;
sub circulating where the process solution moves along the circulating line while passing through a bypass line branching from a first position of the circulating line and then coupling at a second position; and
heating the process solution at a position of the circulating line that excludes a portion between the first position and the second position.

9. The method of claim 8, wherein the sub circulating is performed at an initial stage of a process, and the main circulating is performed at a later stage of the process.

10. The method of claim 9, wherein the main circulating comprises filtering the process solution between the first position and the second position.

11. An apparatus for treating a substrate, the apparatus comprising:
a treating bath in which a process solution for a substrate is provided;
a circulating line which is connected to the treating bath and through which the process solution circulates;
a bypass line branching from a first position of the circulating line and then coupling at a second position of the circulating line; and
a filter installed at a position of the circulating line between the first position and the second position.

12. The apparatus of claim 11, further comprising:
a heater installed on the circulating line; and
a temperature sensor installed on the circulating line and sensing temperature of the process solution.

13. The apparatus of claim 12, further comprising a first valve installed on the bypass line.

14. The apparatus of claim 13, further comprising a second valve installed on the circulating line and located between the first position and the second position.

15. The apparatus of claim 13, further comprising a controller controlling open/close of at least the first valve of the first valve and the second valve depending on the temperature of the process solution sensed by the temperature sensor to control whether to pass the process solution to the bypass line.

16. The apparatus of claim 15, wherein when the temperature of the process solution is smaller than a set value, the controller controls the process solution to circulate through the bypass line.

17. The apparatus of claim 16, wherein the set value is about 50° C. to about 60° C.

18. The apparatus of claim 11, further comprising:
a container storing the process solution; and
a supply line connected the container and the treating bath.

19. The apparatus of claim 18, wherein the container comprises a first container storing H₂SO₄, and a second container storing H₂O₂.

20. An apparatus for treating a substrate, the apparatus comprising:
a treating bath in which a process solution for a substrate is provided;
a circulating line which is connected to the treating bath and through which the process solution circulates;
a bypass line branching from a first position of the circulating line and coupling at a second position of the circulating line; and
a heater installed at a position of the circulating line that excludes a portion between the first position and the second position.
